(19) United States
(12) Patent Application Publication
(10) Pub. No.: US 2020/0037780 A1
(43) Pub. Date: Feb. 6, 2020

(54) SLEEP ACCESSORY FOR CATCHING BED BUGS, AND BED-BUG-CATCHING DEVICE

(71) Applicant: Günter SCHACHINGER, Dobl (AT)

(72) Inventor: Günter SCHACHINGER, Dobl (AT)

(21) Appl. No.: 16/476,359

(22) PCT Filed: Jan. 3, 2018
(86) PCT No.: PCT/EP2018/050118

§ 371 Date: Jul. 8, 2019

(30) Foreign Application Priority Data
Jan. 10, 2017 (AT) A 50008/2017

(51) Int. Cl. A47C 31/00; A01M 1/10

(52) U.S. Cl. CPC A47C 31/007; A01M 1/103

(57) ABSTRACT

The invention relates to a sleep accessory for catching bed bugs, having a closed frame for supporting at least one person, a base being arranged on the frame, which base closes the frame on one side, wherein at least one bed bug trap is arranged on the frame, which bed bug trap continuously encloses the entire frame, a peripheral groove being arranged on upper edges of the frame. According to the invention, all the inner frame sides of the frame and an inner base side of the base and a transition region from the inner base side to the inner frame sides are substantially gap- and/or crack-free, in particular smooth, and the bed bug trap is arranged on a base of the groove.

### CROSS-REFERENCE TO RELATED APPLICATIONS

The present application is a national phase application of PCT Application No. PCT/EP2018/050118, filed Jan. 3, 2018, entitled “SLEEP ACCESSORY FOR CATCHING BEDBUGS AND BED-BUG-CATCHING DEVICE”, which claims the benefit of Austrian Patent Application No. A 50008/2017, filed Jan. 10, 2017, each of which is incorporated by reference in its entirety.

### BACKGROUND OF THE INVENTION

### 1. Field of the Invention

The invention relates to a sleep accessory for bedbug catching.

### 2. Description of the Related Art

Bedbugs are currently spreading more and more. This is due, for example, to strong travel activity and international trade in goods, especially antiques. Bedbugs now also appear in luxury hotels and are by no means a phenomenon of poverty.

Bedbugs spend most of their time hidden in gaps or cracks. At night, bedbugs are attracted by humans and other sleeping warm-blooded animals to seek them out to suck blood. Bedbugs are forced to suck blood at least once during each phase of life in order to develop further.

Bedbugs usually use one of two possible ways to approach the host. Either they reach the bed or bedstead directly via the floor or the wall or they climb over the ceiling to a place above the bed and drop from there onto the bed or the host.

After the blood has been absorbed, the bedbugs retreat back into the gaps or cracks. Neither duvet, pillow, mattress nor the so-called sheet are accepted by the bedbugs as spaces for retreat or rest. In this respect, bedbugs look for narrow gaps or cracks, which are exposed to little or no movement at all. In the bed itself, only the substructure of the bed is suitable as a home for bedbugs.

So far all kinds of bedbug control devices have been proposed, but none of them have been so effective in practical use as to make chemical control of bedbugs obsolete. However, chemical control is also increasingly reaching its limits, as bedbugs are immune to a variety of common insecticides. In addition, the eggs of the bedbugs are not destroyed in any control method, so that bedbug control—to be successful—must be maintained or repeated over a longer period of time.

It has also been shown in development that traps that work with artificial lure bodies, such as heat or CO₂ sources, are usually not accepted when a person is present at the same time. The bedbugs are able to distinguish a human from a lure body. This supports the well-founded assumption that bedbugs are sensitive to other stimuli in addition to body heat and a person's CO₂ output. In this respect, structure-borne sound, vibrations and micro-shocks are considered as possibilities. It is quite conceivable that bedbugs can see from the vibrations or a temporal vibration pattern in a room that a host is entering the surroundings of the bed and is subsequently lying down to sleep, and then also recognize when the host is actually sleeping.

It is therefore the object of the invention to provide a sleep accessory for bedbugs, with which the mentioned disadvantages can be avoided, and with which an effective fight against bedbugs with little impairment of humans is possible. In particular, it is the object to stop or end a bedbug infestation in a building by killing the bedbugs without the use of poison.

### SUMMARY OF THE INVENTION

According to the invention, this is achieved by the features of a sleep accessory for bedbug catching, having a closed frame for receiving a person, and a base arranged on the frame. The base closes the frame on one side, and at least one bedbug trap is arranged on the frame. The bedbug trap continuously encloses the entire frame. All frame inner sides of the frame and a base inner side of the base, as well as a transition region from the base inner side to the frame inner sides, are designed to be free of gaps and/or cracks. A circumferential groove is arranged at frame upper edges of the frame, and the bedbug trap is arranged at a groove base of the groove.

This makes it possible to effectively combat bedbugs. In the sleeping accessory for bedbug catching according to the subject matter, the lure body is used which has proven to be one of the best possible lure bodies, namely the person themselves. Although bedbug bites are unpleasant, they do not pose an immediate health risk and the presence of bedbugs is not perceived by most people at night.

By placing the trap at the base of the groove, the trap can be protected and, above all, the effectiveness of the trap is increased immensely. The bedbugs have to cross the trench of the groove. While the bedbugs shy away from entering a trap, the current effect is that they fall from the edge of the groove and cannot escape. At the edge of the groove they are unable to perceive the trap yet, or they slip off at this point and end up in the bedbug trap. It has been recognized that most bedbugs also end up lying on their backs in or on the bedbug trap, which means that the bedbugs can no longer free themselves.

Bedbugs are usually very careful where they step, and usually enter traps only with the foremost legs, and can often free themselves with the remaining legs from a trap or pull out. This is no longer possible in this case.

In addition, it has been recognized that a considerable majority of bedbugs choose the path across the ceiling of the building or room in order to reach people. All traps that only aim to protect humans from crawling insects from below are therefore not effective to control infestation with bedbugs.

The present sleep accessory for catching bedbugs can easily be placed on most beds, bedsteads or mattresses. Most bedbugs are caught and killed within the first few nights with the present sleep accessory for catching bedbugs. Since the bedbugs coming over the floor are already killed before they bite, humans are only bitten by bedbugs which reach the bed via the ceiling. After that it is only necessary to use the sleep accessory for catching bedbugs for a few weeks in order to safely eliminate the growing generation of bedbugs. This allows effective bedbug control without the need for poison. Furthermore, it is not necessary to free up furniture or make any other changes to the living space. People who live in infested rooms can continue to use them to the full extent and sleep in their existing bed. It is only necessary to spend a few weeks within the frame of the sleep accessory for catching bedbugs.

Since humans lie in a kind of trough, the bedbugs are forced to cross the bedbug trap at least once. The bedbug trap cannot be bypassed by the bedbugs, as is the case with some known adhesive traps.

The present sleep accessory for bedbugs can also be produced with simple tools and is also suitable for use in less developed countries.

Since the frame has no cracks, the bedbugs cannot hide inside the frame itself.

The present sleep accessory makes do without poison, and thus does not promote any further resistance to bedbugs, and also saves the affected people from coming into contact with poisons. Furthermore, the alternative heat treatment of the infested rooms can be dispensed with, which has been the only alternative to poison so far, as such a heat treatment requires a room to be heated to 60° C. for a longer period of time, which is very costly and requires a lot of energy.

The invention also concerns a bedbug catching device for bedbug catching, wherein the bedbug catching device is provided for arrangement on room side walls, a room ceiling, and/or a bed. The bedbug catching device has a circumferentially closed bedbug barrier, wherein the bedbug barrier has at least one first section and at least one second section adjoining the first section. The first section has a bedbug sliding surface for guiding bedbugs towards the second section, and the second section has a bedbug semi-sliding surface. At least one bedbug collecting container is arranged in the region of the second section in such a way that bedbugs pass from the second section into the bedbug collecting container, and in particular fall therefrom.

As already explained in the introduction, many bedbugs prefer to use the ceiling to reach a sleeping host.

It is therefore the object of the invention to provide a bedbug catching device of the type mentioned above, which can avoid the disadvantages mentioned above and which can effectively control bedbugs with little human impairment. In particular, it is the object to stop or end a bedbug infestation in a building by killing the bedbugs without the use of poison.

According to the invention, this is achieved by the features of the present technology.

This makes it possible to effectively combat bedbugs without the need for poison. The bedbug catching device is simple to manufacture and durable. This can be unobtrusively integrated into the design of a bedroom but above all also of a hotel room. This can happen so inconspicuously that a hotel guest does not even notice the bedbug catching device in question, or does not recognize its actual purpose, and simply considers it to be a design element.

This allows practically maintenance-free operation for years, with only occasional emptying of the bedbug collecting container and removal of any dust or dirt deposits on at least one bedbug sliding surface and at least one bedbug semi-sliding surface.

The bedbug catching device makes it possible to ensure that bedbugs encounter a barrier on their way to the sleeping person which does not provide them with sure footing or support in the first sections and which are therefore not entered by the bedbugs. The bedbug catching device in question is intended to be used on vertical walls and/or on a ceiling.

In contrast to many other insects, such as flies, bedbugs do not find support on smooth surfaces and cannot crawl or climb on such surfaces. Bedbugs therefore enter such areas only with their foremost feet and then retreat to find another way. The bedbugs, attracted by the greedy desire to jump down from above onto their sleeping victim, move along the first section of the bedbug barrier until they reach the second section. The second section appears to the bedbugs as a passage or gate within the first section. The surface within the second section is such that while the bedbugs will find sufficient support to crawl further and not be scared off, the bedbug semi-sliding surface thus designated is still smooth enough to cause the bedbugs to lose support as soon as the bedbugs have most of their legs on the surface. Since the bedbug semi-sliding surface is in a vertical or overhead position when the bedbug tries to cross it, the bedbug falls into the bedbug collecting container below.

The subclaims relate to further advantageous embodiments of the invention.

Express reference is hereby made to the wording of the patent claims, whereby the claims are inserted here by reference in the description and are deemed to be reproduced verbatim.

### BRIEF DESCRIPTION OF THE DRAWINGS

The invention is described in more detail with reference to the enclosed drawings, in which only preferred embodiments are shown by way of example, wherein:

FIG. 1 shows a schematic axonometric representation of a sleep accessory at issue on a bed;

FIG. 2 shows a schematic sectional view through a frame of a present sleep accessory, arranged on a mattress;

FIG. 3 shows a schematic representation of a bedbug catching device at issue, which is attached to a ceiling in view from below or in a view A-A according to FIG. 4;

FIG. 4 shows the room with the bedbug catching device according to FIG. 3 in the layout, as well as a bed with a bedbug catching device at issue;

FIG. 5 shows a schematic representation of the second section in the side view or in a view B-B according to FIG. 4;

FIG. 6 shows a schematic representation of a bed for use with a bedbug catching device at issue; and

FIG. 7 shows the detail C according to FIG. 2 with further features.

### DETAILED DESCRIPTION

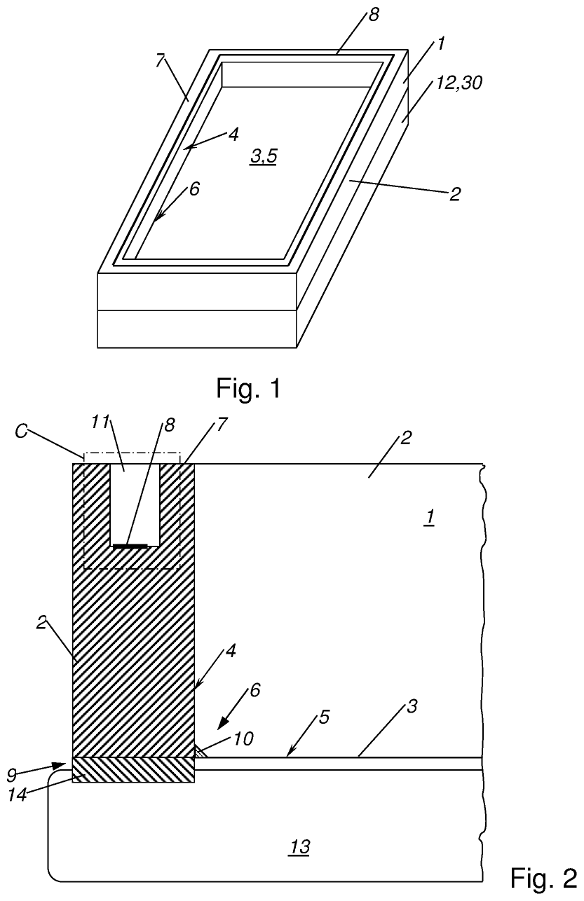

FIGS. 1, 2 and 7 each show a sleep accessory 1 for bedbug catching or a sectional view through a part of such a sleep accessory 1, wherein the sleep accessory 1 has a closed frame 2 for accommodating at least one person, wherein a base 3 is arranged on the frame 2, which base 3 closes the frame 2 on one side, wherein all frame inner sides 4 of the frame 2 and a base inner side 5 of the base 3 as well as a transition region 6 from the base inner side 5 to the frame inner sides 4 are substantially free of gaps and/or cracks, in particular smooth, and wherein at least one bedbug trap 8 is arranged on the frame 2, which bedbug trap 8 encloses the entire frame 2 continuously.

This makes it possible to effectively combat bedbugs. With the present sleep accessory 1 for bedbug catching the lure body is used which proved to be the best possible lure body, namely the human himself. Although bedbug bites are unpleasant, they do not pose an immediate health risk and the presence of bedbugs is not perceived by most people at night.

The present sleep accessory 1 for bedbug catching can be easily placed on most beds 12, bedsteads or mattresses. With the present sleep accessory 1 for catching bedbugs, most bedbugs are caught and killed within the first nights. Since the bedbugs coming over the floor are already killed before they bite, humans are only bitten by bedbugs which reach the bed via the ceiling. Afterwards it is only necessary to use the sleep accessory 1 for catching bedbugs for a few weeks in order to safely eliminate the growing generation of bedbugs. This allows effective bedbug control without the need for poison. Furthermore, it is not necessary to free up furniture or make any other changes to the living space. People who live in infested rooms can continue to use them to the full and sleep in their existing bed. They only have to spend a few weeks within the frame of the sleep accessory 1 to catch bedbugs.

Since the human being lies in a kind of trough, the bedbugs are forced to cross the bedbug trap 8 at least once. The bedbug trap 8 cannot be bypassed by the bedbugs, as is the case with some known adhesive traps.

The present sleep accessory 1 for catching bedbugs can also be produced with simple means and is also suitable for use in less developed countries.

The present device is a device on or in which a trap for crawling arthropods is arranged. Since the actual trap occupies a small part of the device, the device is referred to as a sleep accessory 1 or sleep accessory component or sleep accessory device. Sleep accessory 1 can also be referred to as bedbug catching device, bedbug killing device or similar.

The present sleep accessory 1 is intended to catch or kill bedbugs and has a corresponding bedbug trap 8. In addition, of course, any other arthropod of corresponding size that wants to cross the bedbug trap, especially isopods, spiders, centipedes, etc., is also killed.

The sleep accessory 1 has a closed frame 2, which is so large that at least one person can fit inside the frame 2. It is preferably provided that the sleep accessory 1 is placed on a bed 12, a bed frame or a mattress 13 and that the person lies in the frame 2, wherein the person lies on the actual mattress 13 of the bed 12 in question. The dimensions of frame 2 can therefore vary, as can the dimensions of the beds, depending on region, height and age. In particular, the dimensions of the frame or sleep accessory 1 correspond to the dimensions or layouts of beds. Since these are not standardized, the dimensions of the sleep accessories 1 in question can be varied accordingly. FIG. 1 shows the sleep accessory 1 arranged on a bed 12. The sleep accessory 1 can be arranged on the bed frame or on the mattress 13.

Frame 2 is a frame which is closed on all sides or closed all the way around and can also be referred to as a frame. Frame 2 is preferably made of wood, but can also be made of another material, such as plastic. Frame 2 has a height of at least 10 cm, preferably 15 to 25 cm. Frame 2 shall be of such height that a duvet or other part of bed 12 or a part of the human body cannot form a bridge over frame 2 without this being noticed.

A base 3 is arranged on the underside of frame 2. This base 3 closes the frame 2 on one side, forming a trough or tub. Base 3 must of course not have a hole large enough for a bedbug to slip through. Base 3 is preferably formed in a flexible and resilient manner. In addition to the particularly preferred embodiment of base 3 as including a cloth made of a fabric which is sufficiently dense and stable to be impenetrable to bedbugs, elastomers can also be used, e.g. base 3 can also consist of a latex tarpaulin. Most fabrics used for bed linen already have sufficient impermeability to prevent bedbugs from penetrating them. Although the bedbug's biting tools are suitable for penetrating skin, they are not suitable for textiles.

According to a first preferred embodiment, the base 3 is fixed to an underside 9 of the frame 2 or in the area of the underside, and in particular may be screwed on. As shown in FIG. 2, it may be provided that the base is fastened to the underside by means of a strip 14, which is fastened to the actual frame 2, in particular screwed to it. An adhesive is also preferred in the fastening area.

According to a first preferred embodiment, the base 3 is fixed to the inside of the frame 4, in particular screwed on, wherein the additional use of an adhesive may also be provided.

It is provided that all frame inner sides 4 of the frame 2 and the base inner side 5 of the base 3 as well as a transition region 6 from the base inner side 5 to the frame inner sides 4 are substantially free of gaps and/or cracks, in particular smooth. The entire interior area of sleep accessory 1, therefore the area intended for the presence of a human being in it, must not be a place of retreat for bedbugs. The areas concerned must therefore be free of hiding places for bedbugs. Such gaps must typically be at least 5 mm long, at least 3 mm deep and at least 1 mm wide to be suitable for bedbugs to retreat to. A surface is considered to be free of gaps and/or cracks if its greatest roughness or scratches are smaller than the above values. The frame inner sides 4 are particularly preferred to be coated with a polymeric compound, such as a paint, filler or similar, to ensure that there are no gaps or cracks. However, the roughness must be large enough to allow the bedbugs to crawl or climb. It is therefore preferred that frame 2 has a mean roughness value Ra greater than 200 nm. The surfaces in question should therefore not be smoother than 200 nm or roughness class N4.

It is particularly preferably provided that in the transition area 6 from the base inner side 5 to the frame inner side 4 a sealing compound 10, e.g. silicone, is arranged to ensure that no gaps or cracks can serve as a hiding place for bedbugs in this area as well. This sealing compound 10 can also extend over other areas of the frame inner sides 4.

At least one bedbug trap 8 or the actual killing device is arranged on frame 2, which bedbug trap 8 encloses the entire frame 2 continuously. The actual trap is therefore located on frame 2. The bedbug trap 8 is particularly preferably arranged on the upper frame edges 7 of frame 2. However, it can also be provided to arrange the bedbug trap 8 on the outer surfaces of frame 2. Furthermore, it can be provided to provide a plurality of such bedbug traps 8, which, approximately parallel to each other, are each arranged around the complete frame 2 extending on the sleep accessory 1. This ensures, for example, that even if one of the bedbug traps 8 becomes dirty, the bedbugs will still be forced to cross a bedbug trap 8 and thus die.

It is preferably provided that the bedbug trap 8 is designed as an adhesive trap and/or an electric trap 29. This makes it possible to combat bedbugs safely without releasing poison. In addition, it is safe to assume that such traps are also effective with poison-resistant bedbugs. When using an electric trap 29, it should be noted that this slightly increases the required application time. An electrical trap 29 has conductors arranged at a distance from each other, between which a sufficiently high electrical voltage is applied, which is dangerous for bedbugs. For insulation reasons, a certain minimum distance between the two conductors is required. About 2 mm are typical. Bedbugs in early stages of development can therefore cross such an electrical trap undamaged, as they are small enough to cross the conductors individually. However, before they reach sexual maturity and are able to lay their own eggs, they reach a sufficient height to become a victim of the electric trap 29.

It is provided that a circumferential groove 11 is arranged on the frame 2, in particular the frame upper edges 7, and that the bedbug trap 8 is arranged in the groove 11. The bedbug trap 8 can be protected by the groove 11, which increases its effective duration. Furthermore, a barrier is created which the bedbug 8 has to overcome. In addition, the probability is kept low that the bedbug trap 8 will be unintentionally bridged, for example by dust accumulation.

The frame upper edges 7 are edges of frame 2, which is preferably the uppermost edge of frame 2 in the position of use. However, it may be provided that frame 2 has even higher areas, for example facing the interior of frame 2. This can be designed as a further frame within the actual frame 2 with the groove 11.

FIG. 2 shows a sectional view through a frame 2, clearly showing the groove 11 arranged at the upper edge, within which the bedbug trap 8 is arranged. The frame 2 is arranged directly on the mattress 13. During operation, the flexible base 3 will rest against the mattress. The bedbug trap 8 is only arranged at the base 16 of the groove 11, as shown in FIGS. 2 and 7. Outside the invention, it may also be provided to arrange one or more bedbug traps 8 on groove side surfaces or side walls 17 of groove 11.

It is preferably provided that a bedbug sliding surface 18 is arranged at least in certain areas on side walls 17 of the groove 11. In particular, it is provided that at least one such bedbug sliding surface 18 is arranged on each of the side walls 17 of the groove 11. In particular, the bedbug sliding surface 18 runs without interruption or gaps through or around the entire groove 11.

The side walls 17 of the groove 11 are designed in particular as steeply sloping or undercut side walls 17. It has proved to be advantageous if the side walls 17 drop steeply, especially in the area of a groove edge 19 of the groove 11. In particular, the side walls 17 of the groove 11 have an angle of 90° to the frame upper edge 7, as shown in FIGS. 2 and 7. The bedbug sliding surface 18 is not shown in FIG. 2, but is also preferably provided.

A bedbug sliding surface 18 is a solid surface which is so smooth that bedbugs cannot find a foothold on it and can neither cling to it nor climb or crawl on it. The suitability of a surface as a bedbug sliding surface 18 can easily be tested by means of a few tests with real bedbugs. If bedbugs are placed on an essentially horizontally arranged bedbug sliding surface 18, they can hardly move by their own force. In this respect, they resemble the movement of a human being on black ice. If the test surface in question is tilted, the bedbugs slip off. In particular, it is provided that the bedbug sliding surface 18 has a mean roughness value Ra of less than 20 nm, in particular less than 10 nm. It has been recognized that bedbugs can no longer find support on such smooth, solid surfaces and that it is impossible for them to move around.

The bedbug sliding surface 18 can prevent a bedbug from climbing down the side walls 17 of groove 11, testing the glue trap 8 on the groove base 16 of groove 11, freeing itself from it again and then climbing up groove 11 again. Due to the bedbug sliding surface 18, the bedbug loses its hold unexpectedly when attempting to climb down the groove 11 and falls into bedbug trap 8 upside down or in a supine position.

It has proved to be particularly effective if the bedbug sliding surface 18 does not begin directly at the groove edge 19, but is arranged slightly offset in the direction of the groove base 16. In particular, it is therefore provided that the bedbug sliding surface 18 can be pre-set from a groove edge 19 of the groove 11, in particular from 2 mm to 4 mm, at a distance. This can cause the bedbug to climb down into groove 11 before it loses its hold. If the bedbug detects that the forward or downward path is not suitable for crawling further down, it is already upside down in an unfavorable position for it.

It is preferably provided that the bedbug sliding surface 18 has a width of more than 6 mm, in particular more than 7 mm. This makes it impossible even for full-grown bedbugs to exceed or climb over the bedbug sliding surface 18 without losing their hold.

Generally speaking, any sufficiently smooth material is suitable to form the bedbug sliding surface 18. It has been shown to be advantageous in practice if the bedbug sliding surface 18 is formed by a glass surface or a PTFE surface or PMMA surface or Plexiglas surface. Furthermore, however, surfaces made of or including glazed ceramics or porcelain, metals and enamel are also suitable.

According to another embodiment it is provided that frame 2 has a higher head area than the rest of frame 2 and that the bedbug trap 8 also extends along side edges of the head area. This ensures that even when sitting up in the bed 12 no bridge is formed to a rear wall of room 32.

Furthermore, it may be provided that fastening means for releasably fastening a duvet and/or a pillow are arranged on the base inner side 5 and/or at least one of the frame inner sides 4, in particular the raised head region. These can be designed as buttons, for example, to which one side of the duvet or pillow can be attached in order to prevent them from being moved during sleep in such a way that they form a bridge over the bedbug trap 8.

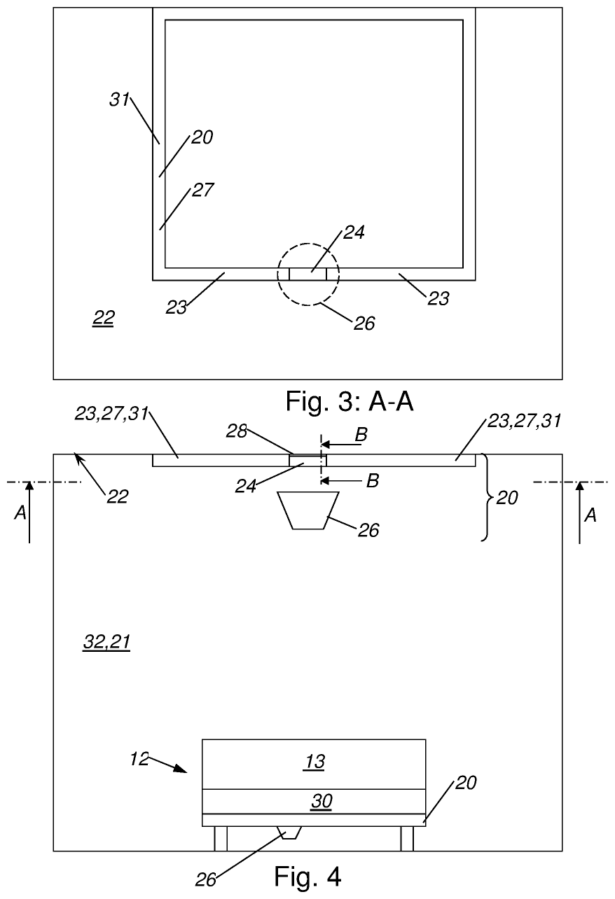

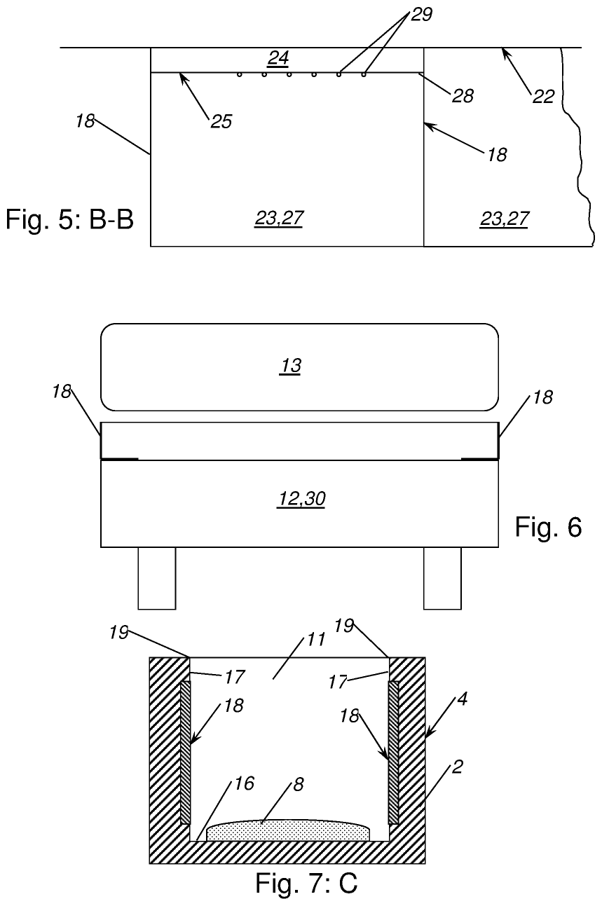

FIGS. 3, 4 and 5 each show a bedbug catching device 20 for bedbug catching or a detail of such a bedbug catching device 20, wherein the bedbug catching device 20 is provided for arrangement on room side walls 21 and/or a room ceiling 22 and/or a bed 12, wherein the bedbug catching device 20 has a circumferentially closed bedbug barrier 31, wherein the bedbug barrier 31 has at least one first section 23 and at least one second section 24 adjoining the first section 23, wherein the first section 23 has a bedbug sliding surface 18 for guiding bedbugs towards the second section 24, wherein the second section 24 has a bedbug semi-sliding surface 25, wherein at least one bedbug collecting container 26 is arranged in the region of the second section 24 in such a way that bedbugs pass from the second section 24 into the bedbug collecting container 26, in particular fall into said container.

This makes it possible to effectively control bedbugs without the need for poison. The bedbug catching device 20 is easy to manufacture and durable. This can be unobtrusively integrated into the design of a bedroom but above all also of a hotel room. This can happen so inconspicuously that a hotel guest does not even notice the respective bedbug catching device 10 or does not recognize its actual purpose and simply considers it to be a design element.

This allows practically maintenance-free operation for years, with only occasional emptying of the bedbug collecting container 26 and removal of any dust or dirt deposits on at least one bedbug sliding surface 18 and at least one bedbug semi-sliding surface 25.

The bedbug catching device 20 can be used to ensure that bedbugs encounter a barrier on their way to the sleeping person, which does not provide them with sure footing or support in the first sections 23, and which are therefore not entered by the bedbugs. The bedbug catching device 20 is intended to be used on vertical walls 21 and/or on a ceiling 22.

In contrast to many other insects, such as flies, bedbugs do not find support on smooth surfaces and cannot crawl or climb on such surfaces. Bedbugs therefore enter such areas only with their foremost feet and then retreat to find another way. The bedbugs, attracted by the greedy urge to jump down from above onto their sleeping victim, move along the first section 23 of the bedbug barrier 31 until they reach the second section 24. The second section 24 appears to the bedbugs as a passageway or gate within the first section 23. The surface within the second section 24 is such that the bedbugs find sufficient support to crawl further and not be scared off, but the bedbug semi-sliding surface 25 thus designated is still so smooth that the bedbug loses support as soon as it is on the surface with the most legs or is disturbed in any way. Since the bedbug semi-sliding surface 25 is in a vertical or overhead position when the bedbug tries to cross it, the bedbug falls into the bedbug collecting container 26 below.

The bedbug catching device 20 is especially designed to be fixed or permanently installed in a room 32 or room of a building, especially a bedroom. In this sense, the bedbug catching device 20 can also be referred to as a room element or room equipment element for bedbug interception. The bedbug catching device 20 is intended for arrangement on room side walls 21 and/or a room ceiling 22. A ceiling 22 or room ceiling is also called a ceiling. Alternatively, and as shown in FIG. 4, it can also be provided to arrange them on a bed 12.

The bedbug catching device 20 has a circumferentially closed bedbug barrier 31. FIGS. 3 and 4 show different views of a room 12 with a present bedbug catching device 20 and a bed 12 arranged in room 32. The bedbug catching device 20 is located above bed 12 on room ceiling 22 of room 32 and completely surrounds bed 12. Bedbugs, which therefore try to take up a position vertically above at least one sleeping person at night in order to fall on them, are therefore forced to try to overcome or penetrate the bedbug barrier 31.

Even if there are hiding places for bedbugs within the bedbug barrier 31, they must try to overcome the bedbug barrier 31 at the latest after the first sucking to get back to their hiding places.

The bedbug barrier 31 is completely separated into a first section 23 and at least one second section 24, which adjoins the first section 23. The first section 23 occupies the predominant part of the bedbug barrier 31. This is intended to form a barrier, insurmountable for bedbugs, but at the same time also a guiding wall. The first section 23 has a bedbug sliding surface 18. As already explained, bedbugs only enter such areas with their foremost legs to the extent that they cannot find a foothold on them and are also unable to crawl thereon. Bedbugs, which therefore run into this bedbug barrier 31, are forced to follow it to find a gap or a passage.

The first section 23 is preferably designed as a surface and/or a strip 27. It has been shown that a width of one centimeter, in particular 15 mm, is sufficient when the surface is designed as a surface. When designed as strip 27, a height of 5 to 7 mm from the surrounding wall is preferably provided. Notice must be taken concerning any unevenness of the wall in order to avoid transfer points. The strip 27 can be designed as part of a lighting fixture.

With regard to the preferred embodiment and characteristics of the bedbug sliding surface 18, reference is made to the embodiments of sleep accessory 1, wherein only the preferred average roughness value Ra of less than 20 nm, in particular less than 10 nm, is repeated here.

The bedbugs find this passage in the at least one second section 24, which can be very narrow compared to the first section 23, with only a few centimeters length or width. The second section 24 has a bedbug semi-sliding surface 25.

The respective bedbug semi-sliding surface 25 is a surface that is so smooth that bedbugs cannot find a secure hold and, at the same time, is so rough that bedbugs (still) enter it. Bedbugs find a certain foothold or sure footing on such surfaces but have to move carefully. This is also easy to find out by experiments with real bedbugs. It is preferably provided that the bedbug semi-sliding surface 25 has a mean roughness value Ra between less than 150 nm and greater than 50 nm.

The bedbugs thus enter the bedbug semi-sliding surface 25, which, however, is arranged on the room ceiling 22 or the room side wall 21. According to a particularly simple embodiment of the invention, no further measures are provided, but the bedbugs lose the hold on the bedbug semi-sliding surface 25 and fall or slide from there, into the correspondingly positioned bedbug collecting container 26, which has steep walls with bedbug sliding surfaces 18. Whether the bedbugs survive within the bedbug collecting container 26 is irrelevant, as they cannot leave it again. Either the bedbugs starve to death in the bedbug collecting container 26 or the bedbug collecting container 26 is emptied, for example into a toilet or a fireplace. The bedbug collecting container 26 can be easily integrated into a fire detector or a lamp and thus camouflaged.

It has been shown that the performance of the bedbug catching device 20 can be significantly increased by appropriate design of the second section 23.

According to a first further development, it is preferably provided that the second section 24 has a step-like elevation 28 or depression. This forces the bedbug to overcome the second section 24 and to assume an unfavorable position for its holding capability. In practice, it has proven to be particularly effective if the step-shaped elevation 28 or depression has a height or depth of 0.3 mm to 0.7 mm, in particular 0.5 mm. The height or depth is measured in relation to the surrounding room ceiling 22 or room wall 21. By providing the step, a bedbug semi-sliding surface 25 can be selected which has a rougher surface, and is thus better accepted by the bedbugs, in the sense that the respective surfaces are more likely to be walked on by bedbugs than smoother surfaces.

According to an alternative or additional second further development, it is preferably provided that an electric trap 29 is arranged in the second section 24. This only has to be so strong that the bedbugs are distracted or unsettled or frightened for a short time before they fall or slip from the second section 24.

It has also been recognized that the shape of the transitions from the first section 23 to the second section 24 can have an influence. A funnel-shaped design of the second section 24 has proven to be advantageous.

FIG. 4 also shows a bed 12 with a present bedbug catching device 20, wherein the bedbug catching device 20 is arranged on an underside of a frame 30 of the bed 12 so that bedbugs are forced to cross the bedbug catching device 20 on their way from the floor of room 32 to a human being.

Alternatively, a bed 12 according to FIG. 6 can also be provided together with a bedbug catching device 20. Such a bed 12 itself has no trap or catching device but is only designed to prevent bedbugs from reaching bed 12 from the floor. For this purpose, the subfloor must be made bedbug-proof, and a bedbug sliding surface 18 is arranged on bed 12 around bed 12. FIG. 6 shows angled bedbug sliding surfaces 18, which enclose the mattress 13 which is shown in a raised manner Since the bedbugs in such a bed 12 are not able to reach the bed 12 from underneath, they are forced to go over the ceiling 22, and thus to reach the effective area of the bedbug catching device 20.

A combination of all the means described or a selection of said means is provided with the scope of a system for bedbug catching.

1-20. (canceled)

21. A sleep accessory for bedbug catching, comprising:
a closed frame for receiving at least one person;
a base arranged on the frame, the base closing the frame on one side; and
at least one bedbug trap arranged on the frame, the at least one bedbug trap continuously enclosing the entire frame,
wherein the frame and the base form a trough,
wherein all frame inner sides of the frame, a base inner side of the base, and a transition region from the base inner side to the frame inner sides are substantially free of gaps and cracks,
wherein a circumferential groove is arranged at frame upper edges of the frame, and
wherein the bedbug trap is arranged at a groove base of the circumferential groove.

22. The sleep accessory according to claim 21, wherein a bedbug sliding surface is arranged at least in regions on side walls of the groove.

23. The sleep accessory according to claim 22, wherein the bedbug sliding surface is arranged so as to be predeterminably spaced from a groove edge of the groove.

24. The sleep accessory according to claim 22, wherein the bedbug sliding surface has a width of more than 6 mm.

25. The sleep accessory according to claim 22, wherein the bedbug sliding surface has a mean roughness value Ra smaller than 20 nm.

26. The sleep accessory according to claim 22, wherein the bedbug sliding surface is formed by one of a glass surface, a PTFE surface, and a PMMA surface.

27. A bed with a sleep accessory according to claim 21, wherein the sleep accessory is arranged on a frame of the bed.

28. A bedbug catching device for bedbug catching and for arrangement on at least one of room side walls, a room ceiling, and a bed, comprising:
a circumferentially closed bedbug barrier;
at least one first section and at least one second section adjoining the first section, the first section having a bedbug sliding surface for guiding bedbugs towards the second section, the second section having a bedbug semi-sliding surface and a step-shaped elevation or a depression; and
at least one bedbug collecting container arranged beneath the bedbug semi-sliding surface in a region of the second section in such a way that bedbugs pass from the second section into the bedbug collecting container.

29. The bedbug catching device according to claim 28, wherein the bedbug sliding surface has a mean roughness value Ra smaller than 20 nm.

30. The bedbug catching device according to claim 28, wherein the bedbug semi-sliding surface is smooth to such an extent that bedbugs cannot find a secure hold and at the same time is rough to such an extent that it is entered by bedbugs.

31. The bedbug catching device according to claim 28, wherein the bedbug semi-sliding surface has a mean roughness value Ra less than 150 nm and greater than 50 nm.

32. The bedbug catching device according to claim 28, wherein the first section is designed as at least one of a surface and a strip.

33. The bedbug catching device according to claim 28, wherein:
when the second section has the step-shaped elevation, the step-shaped elevation has a height of 0.3 mm to 0.7 mm; and
when the second section has the depression, the depression has a depth of 0.3 mm to 0.7 mm.

34. The bedbug catching device according to claim 33, wherein an electric trap is arranged in the second section.

35. The bedbug catching device according to claim 28, wherein the bedbug collecting container has steep walls with a further bedbug sliding surface.

36. A bed having the bedbug catching device according to claim 28, wherein the bedbug catching device is disposed on an underside of a frame of the bed.

37. A room with a bedbug catching device according to claim 28, wherein the bedbug catching device is arranged above a bed in the room and completely surrounds the bed.

38. The room according to claim 37, wherein the bed has a further bedbug catching device disposed on an underside of a frame of the bed, the further bedbug catching device comprising:
a further circumferentially closed bedbug barrier;
at least one further first section and at least one further second section adjoining the further first section, the further first section having a further bedbug sliding surface for guiding bedbugs towards the further second section, the further second section having a further bedbug semi-sliding surface and a further step-shaped elevation or a further depression; and
at least one further bedbug collecting container arranged beneath the further bedbug semi-sliding surface in a further region of the further second section in such a way that bedbugs pass from the further second section into the further bedbug collecting container.

39. A bedbug catching system comprising:
a bedbug catching device according to claim 28; and
at least one bed having a sleep accessory arranged on a frame of the bed, the sleep accessory being for bedbug catching and including:
a closed frame for receiving at least one person;
a base arranged on the frame, which base closes the frame on one side; and
at least one bedbug trap arranged on the frame, the at least one bedbug trap continuously enclosing the entire frame,
wherein the frame and the base form a trough,
wherein all frame inner sides of the frame, a base inner side of the base, and a transition region from the base inner side to the frame inner sides are substantially free of gaps and cracks,
wherein a circumferential groove is arranged at frame upper edges of the frame, and
wherein the bedbug trap is arranged at a groove base of the circumferential groove.
